(19) United States
(12) Patent Application Publication
(10) Pub. No.: US 2025/0323989 A1
(43) Pub. Date: Oct. 16, 2025

(54) STRAIN-BASED SENSOR CONFIGURATION IN A MOBILE COMMUNICATION DEVICE

(71) Applicant: Qorvo US, Inc., Greensboro, NC (US)

(72) Inventors: Bryan Low, San Mateo, CA (US); Victor Sutardja, Saratoga, CA (US)

(21) Appl. No.: 19/089,840

(22) Filed: Mar. 25, 2025

Related U.S. Application Data
(60) Provisional application No. 63/634,180, filed on Apr. 15, 2024.

(51) Int. Cl. H04M 1/02

(52) U.S. Cl. CPC H04M 1/0266; H04M 2250/12; H04M 2250/22

(57) ABSTRACT

Strain-based sensor configuration in a mobile communication device is provided. In embodiments disclosed herein, a cut slot and an additional sensor(s) are added in a mid-frame of the mobile communication device, in addition to an existing sensor(s) in the mid-frame. The additional sensor(s) can help differentiate an unintended press from an intended press to thereby improve accuracy and reliability in determining strength and position of the press.

### RELATED APPLICATIONS

This application claims the benefit of U.S. provisional patent application Ser. No. 63/634,180, filed on Apr. 15, 2024, the disclosure of which is hereby incorporated herein by reference in its entirety.

### FIELD OF THE DISCLOSURE

The technology of the disclosure relates generally to strain-based force and positional determination in a mobile communication device.

### BACKGROUND

Mobile communication devices have become increasingly common in current society for providing wireless communication services. The prevalence of these mobile communication devices is driven in part by the many functions that are now enabled on such devices. Increased processing capabilities in such devices means that mobile communication devices have evolved from being pure communication tools into sophisticated mobile multimedia centers that enable enhanced user experiences.

FIG. 1A is a schematic diagram providing an exemplary sideview of a mobile communication device 10. The mobile communication device 10, which can be a smartphone, a tablet, and so on, typically includes a mid-frame 12, a display module 14 provided on top of the mid-frame 12, and a back cover 16 provided underneath the mid-frame 12.

FIG. 1B is a schematic diagram providing an exemplary top view of the mid-frame 12 in FIG. 1A. Herein, the mid-frame 12 is encompassed by a side wall 18, wherein a section of the side wall 18 is configured to function as a press region 20. Underneath the press region 20, one or more sensors 22 are provided to detect a deformation of the side wall 18 when an external force (e.g., finger press) is applied to the press region 20 and, accordingly, trigger an intended action(s) in the mobile communication device 10.

Often times, the side wall 18 is made of a seamless structure (e.g., metal) to help improve water resistance. Such a seamless design of the side wall 18 creates some challenges for the sensors 22 to differentiate between an intended press inside the press region 20 and an unintended press outside the press region 20. Adding to this challenge is the addition of a sliding function whereby a press along the side wall 18 can be used to calculate a position and/or a gesture. It is thus desirable to optimize the sensor configuration in the mobile communication device 10 to provide accurate and reliable strength and position determination.

### SUMMARY

Embodiments of the disclosure relate to a strain-based sensor configuration in a mobile communication device. In embodiments disclosed herein, a cut slot and an additional sensor(s) are added in a mid-frame of the mobile communication device, in addition to an existing sensor(s) in the mid-frame. The additional sensor(s) can help differentiate an unintended press from an intended press to thereby improve accuracy and reliability in determining strength and position of the press.

In one aspect, a mobile communication device is provided. The mobile communication device includes a display module and a back cover. The mobile communication device also includes a mid-frame. The mid-frame is provided between the display module and the back cover. The mid-frame includes a side wall encompassing the mid-frame, wherein a section of the side wall is configured to function as a press region. The mid-frame also includes a cut slot that is longer than the press region and extends in parallel to the press region inside the mid-frame. The mid-frame also includes multiple sensors provided inside the cut slot. The multiple sensors are configured to detect a side wall deformation caused by an external force.

In another aspect, a method for enabling a strain-based sensor configuration in a mobile communication device is provided. The method includes configuring a section of a side wall encompassing a mid-frame of the mobile communication device to function as a press region. The method also includes providing a cut slot that is longer than the press region and extends in parallel to the press region inside the mid-frame. The method also includes providing multiple sensors inside the cut slot to detect a side wall deformation caused by an external force.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIGS. 1A and 1B are schematic diagrams of an exemplary mobile communication device configured according to an existing strain-based sensor configuration;

FIGS. 2A-2C are schematic diagrams of exemplary mobile communication devices configured according to an improved strain-based sensor configuration of the present disclosure;

FIG. 3 is a schematic diagram illustrating an exemplary mobile communication device configured according to an alternative embodiment of the present disclosure;

FIG. 4 is a schematic diagram of an exemplary communication device that can function as the mobile communication devices of FIGS. 2A-2C and 3; and

FIG. 5 is a flowchart of an exemplary process for enabling the strain-based sensor configuration in the mobile communication devices of FIGS. 2A-2C and 3.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Embodiments of the disclosure relate to a strain-based sensor configuration in a mobile communication device. In embodiments disclosed herein, a cut slot and an additional sensor(s) are added in a mid-frame of the mobile communication device, in addition to an existing sensor(s) in the mid-frame. The additional sensor(s) can help differentiate an unintended press from an intended press to thereby improve accuracy and reliability in determining strength and position of the press.

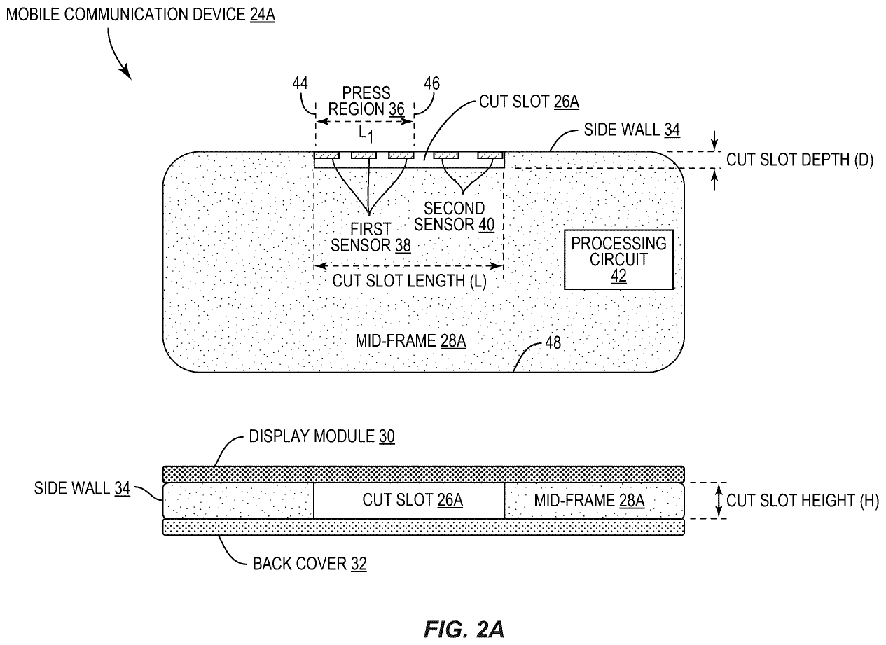

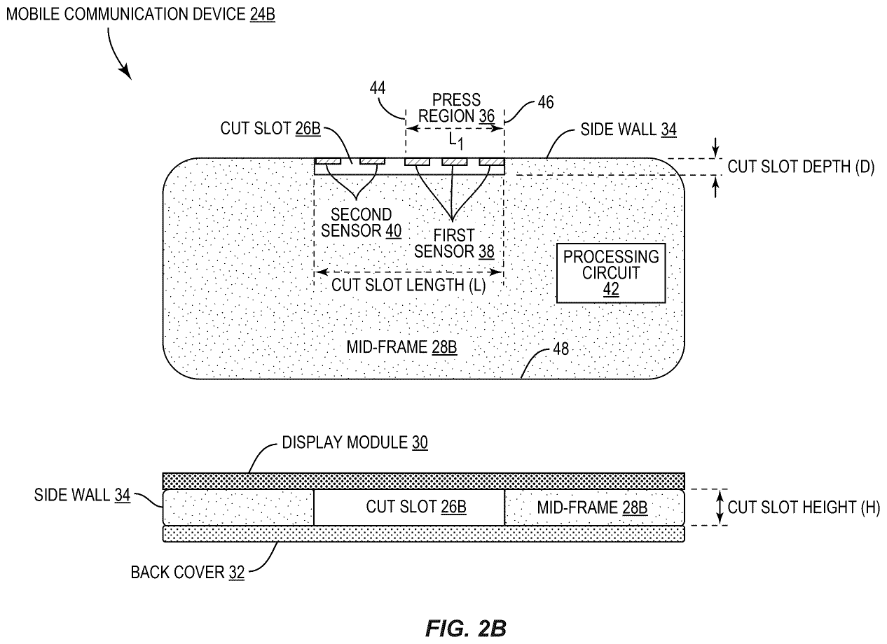

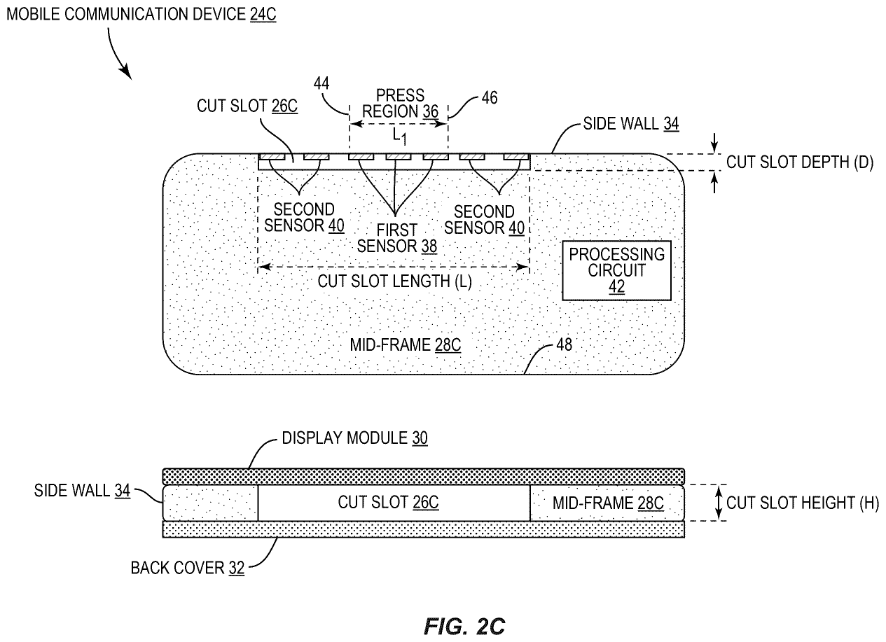

FIGS. 2A-2C are schematic diagrams of exemplary mobile communication devices configured according to an improved strain-based sensor configuration of the present disclosure. Common elements between FIGS. 2A-2C are shown therein with common element numbers and will not be re-described herein.

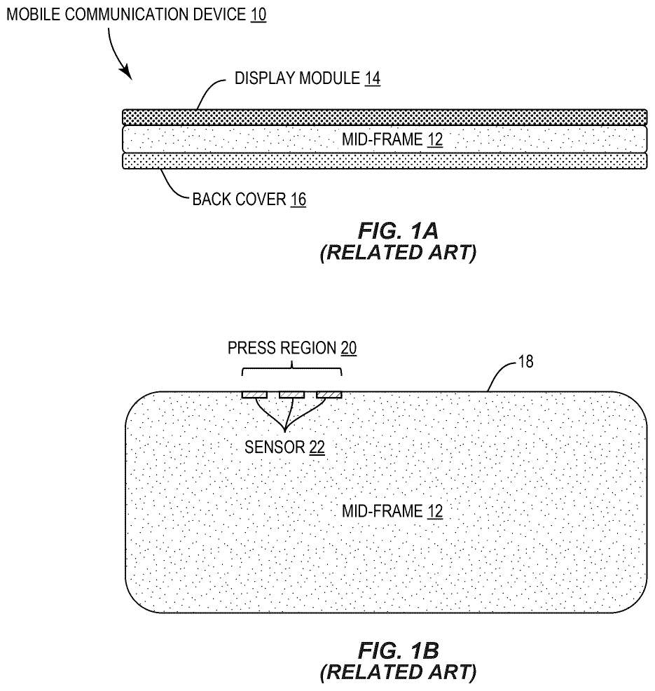

FIG. 2A illustrates an exemplary mobile communication device 24A, wherein a cut slot 26A is provided in a mid-frame 28A. Herein, the mid-frame 28A, which can be functionally equivalent to the mid-frame 12 in FIGS. 1A and 1B, is sandwiched between a display module 30 and a back cover 32.

The mid-frame 28A is encompassed (a.k.a. bounded) by a side wall 34, which can be a seamless structure (e.g., a metal strip) that seals up the mid-frame 28A from external moisture. Like in the mobile communication device 10 of FIG. 1, a section of the side wall 34 is configured to function as a press region 36 wherein one or more first sensors 38 are deployed to detect an external force (e.g., finger press) applied to the press region 36.

Herein, the cut slot 26A is provided inside the mid-frame 28A, along the side wall 34, and in parallel to the press region 36. The cut slot 26A is configured to be longer than the press region 36 to accommodate one or more second sensors 40. Preferably, the first sensors 38 and the second sensors 40 are the same type of sensors, such as pressure sensors, strain sensors, force sensors, and so on.

According to an embodiment of the present disclosure, the first sensors 38 are provided in the cut slot 26A and within the press region 36 to detect the external force applied in the press region 36. The second sensors 40, on the other hand, are provided in the cut slot 26A but outside the press region 36 to detect the external force applied outside the press region 36. The sensory data generated by the first sensors 38 and the second sensors 40 can be fed to a processing circuit 42 (e.g., a microprocessor) to help determine the strength and position of the external force. By adding the second sensors 40 in the mid-frame 28A, it is thus possible to differentiate an intended press from an unintended press to thereby improve accuracy and reliability in strength and position determination.

The cut slot 26A has a respective length L that is up to twice as long as a respective length Li of the press region 36, a respective height H as thick as the mid-frame 28A, and a respective depth D of approximately one millimeter (1 mm). Herein, the cut slot 26A extends along the press region 36 from one side 44 of the press region 36 to beyond another side 46 of the press region 36. The cut slot 26A also extends perpendicularly from the press region 36 toward an opposing side 48 of the side wall 34. As illustrated herein, the second sensors 40 are all provided on the side 46 of the press region 36.

FIG. 2B illustrates an exemplary mobile communication device 24B, wherein a cut slot 26B is provided in a mid-frame 28B. Herein, the cut slot 26B extends along the press region 36 from one side 46 of the press region 36 to beyond another side 44 of the press region 36. As illustrated herein, the second sensors 40 are all provided on the side 44 of the press region 36.

FIG. 2C illustrates an exemplary mobile communication device 24C, wherein a cut slot 26C is provided in a mid-frame 28C. Herein, the cut slot 26C extends beyond both the sides 44 and 46 of the press region 36. As illustrated herein, the second sensors 40 are all provided on both sides 44 and 46 of the press region 36.

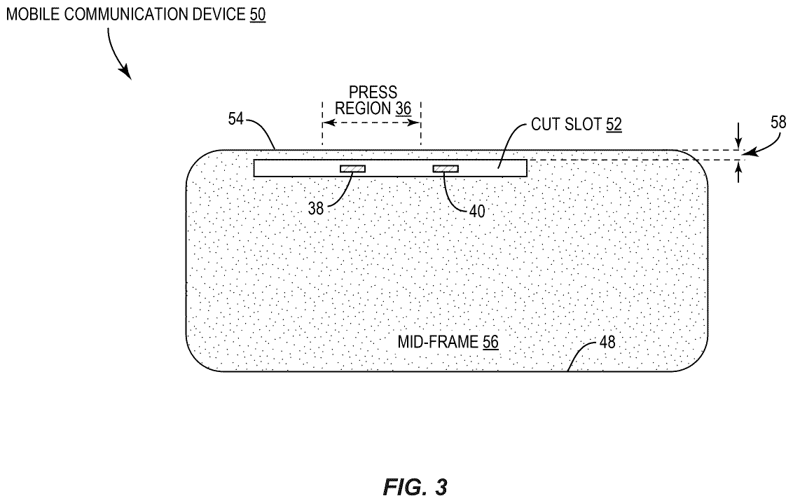

The cut slot 26A in FIG. 2A, the cut slot 26B in FIG. 2B, and the cut slot 26C in FIG. 2C are all annexed to the side wall 34. FIG. 3 is a schematic diagram illustrating a mobile communication device 50 wherein a cut slot 52 is separated from a side wall 54 of a mid-frame 56 by a gap 58. Common elements between FIGS. 2A-2C and 3 are shown therein with common element numbers and will not be re-described herein.

As illustrated herein, a section of the side wall 54 is also configured to function as the press region 36, as illustrated in FIGS. 2A-2C. In this regard, the first sensors 38 and the second sensors 40 should be provided in the side wall 54 as in the cut slot 26A in FIG. 2A, the cut slot 26B in FIG. 2B, or the cut slot 26C in FIG. 2C.

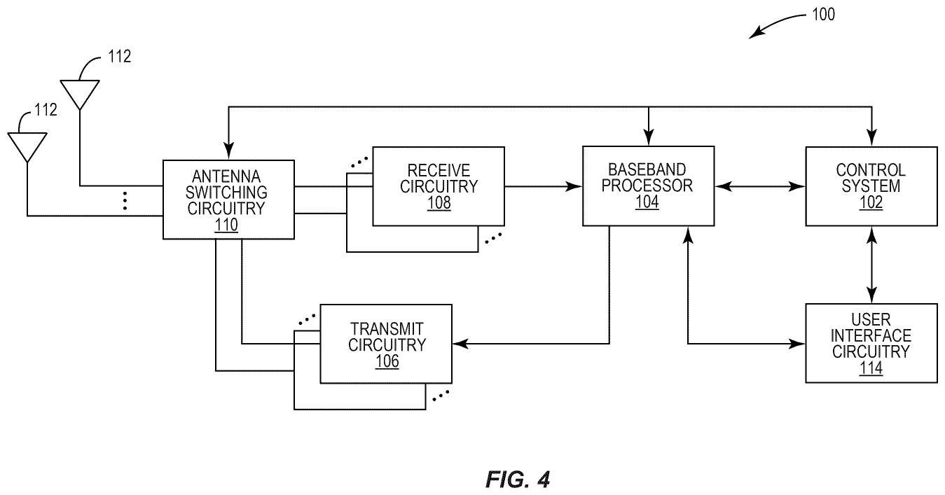

FIG. 4 is a schematic diagram of an exemplary communication device 100 that can function as the mobile communication device 24A of FIG. 2A, the mobile communication device 24B of FIG. 2B, the mobile communication device 24C of FIG. 2C, and the mobile communication device 50 of FIG. 3.

Herein, the communication device 100 can be any type of communication device, such as mobile terminal, smart watch, tablet, computer, navigation device, access point, base station (e.g., eNB, gNB, etc.), and any other type of wireless communication device that support wireless communications, such as cellular, wireless local area network (WLAN), Bluetooth, Ultra-wideband (UWB), and near field communications. The communication device 100 will generally include a control system 102, a baseband processor 104, transmit circuitry 106, receive circuitry 108, antenna switching circuitry 110, multiple antennas 112, and user interface circuitry 114. In a non-limiting example, the control system 102 can be a field-programmable gate array (FPGA), as an example. In this regard, the control system 102 can include at least a microprocessor(s), an embedded memory circuit(s), and a communication bus interface(s). The receive circuitry 108 receives radio frequency signals via the antennas 112 and through the antenna switching circuitry 110 from one or more base stations. A low noise amplifier and a filter cooperate to amplify and remove broadband interference from the received signal for processing. Downconversion and digitization circuitry (not shown) will then downconvert the filtered, received signal to an intermediate or baseband frequency signal, which is then digitized into one or more digital streams using an analog-to-digital converter(s) (ADC).

The baseband processor 104 processes the digitized received signal to extract the information or data bits conveyed in the received signal. This processing typically comprises demodulation, decoding, and error correction operations, as will be discussed in greater detail below. The baseband processor 104 is generally implemented in one or more digital signal processors (DSPs) and application specific integrated circuits (ASICs).

For transmission, the baseband processor 104 receives digitized data, which may represent voice, data, or control information, from the control system 102, which it encodes for transmission. The encoded data is output to the transmit circuitry 106, where a digital-to-analog converter(s) (DAC) converts the digitally encoded data into an analog signal and a modulator modulates the analog signal onto a carrier signal that is at a desired transmit frequency or frequencies. A power amplifier will amplify the modulated carrier signal to a level appropriate for transmission, and deliver the modulated carrier signal to the antennas 112 through the antenna switching circuitry 110. The multiple antennas 112 and the replicated transmit and receive circuitries 106, 108 may provide spatial diversity. Modulation and processing details will be understood by those skilled in the art.

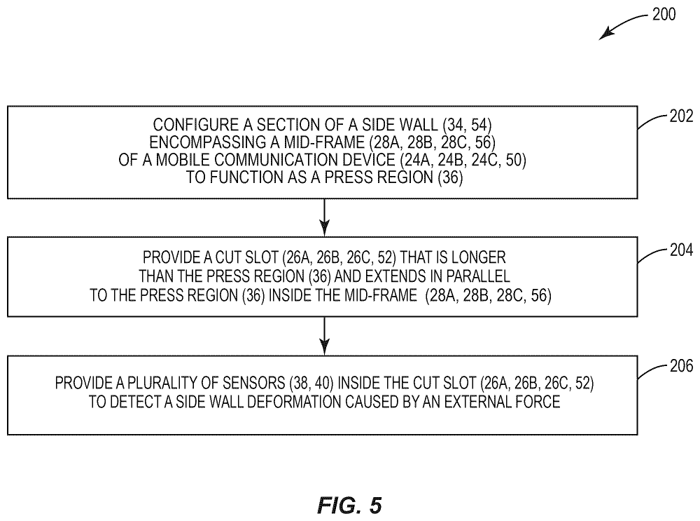

In an embodiment, the mobile communication device 24A of FIG. 2A, the mobile communication device 24B of FIG. 2B, the mobile communication device 24C of FIG. 2C, and the mobile communication device 50 of FIG. 3 can be configured to support a strain-based sensor in accordance with a process. In this regard, FIG. 5 is a flowchart of an exemplary process 200 for enabling a strain-based sensor configuration in the mobile communication device 24A of FIG. 2A, the mobile communication device 24B of FIG. 2B, the mobile communication device 24C of FIG. 2C, and the mobile communication device 50 of FIG. 3.

Herein, the process 200 includes configuring a section of a side wall 34, 54 encompassing the mid-frame 28A, 28B, 28C, 56 of the mobile communication device 24A, 24B, 24C, 50 to function as the press region 36 (step 202). The process 200 also includes providing the cut slot 26A, 26B, 26C, 52 that is longer than the press region 36 and extends in parallel to the press region 36 inside the mid-frame 28A, 28B, 28C, 56 (step 204). The process 200 also includes providing the sensors 38, 40 inside the cut slot 26A, 26B, 26C, 52 to detect the side wall deformation caused by the external force (step 206).

Those skilled in the art will recognize improvements and modifications to the preferred embodiments of the present disclosure. All such improvements and modifications are considered within the scope of the concepts disclosed herein and the claims that follow.

What is claimed is:

1. A mobile communication device comprising:
a display module and a back cover; and
a mid-frame provided between the display module and the back cover and comprising:
a side wall encompassing the mid-frame, wherein a section of the side wall is configured to function as a press region;
a cut slot that is longer than the press region and extends in parallel to the press region inside the mid-frame; and
a plurality of sensors provided inside the cut slot and configured to detect a side wall deformation caused by an external force.

2. The mobile communication device of claim 1, wherein the cut slot has a respective length up to twice as long as the press region, a respective height as thick as the mid-frame, and a respective depth of approximately one millimeter.

3. The mobile communication device of claim 1, wherein the cut slot extends along the press region from one side of the press region to beyond another side of the press region.

4. The mobile communication device of claim 1, wherein the cut slot extends along the press region and beyond both sides of the press region.

5. The mobile communication device of claim 1, wherein each of the plurality of sensors is one of a pressure sensor, a force sensor, and a strain sensor.

6. The mobile communication device of claim 1, wherein the plurality of sensors comprises:
one or more first sensors provided in the cut slot within the press region and configured to detect the external force applied in the press region; and
one or more second sensors provided in the cut slot but outside the press region and configured to detect the external force applied outside the press region.

7. The mobile communication device of claim 6, wherein the one or more second sensors are provided on one side of the one or more first sensors.

8. The mobile communication device of claim 6, wherein the one or more second sensors are provided on both sides of the one or more first sensors.

9. The mobile communication device of claim 6, further comprising a processing circuit configured to:
receive a sensory input from each of the plurality of sensors; and
determine a location whereat the external force is applied, and a strength of the external force is based on the sensory input received from each of the plurality of sensors.

10. The mobile communication device of claim 9, wherein the processing circuit is further configured to:
determine an intended press in the press region based on the location and the strength of the external force determined from the sensory input received from each of the one or more first sensors; and
determine an unintended press outside the press region based on the location and the strength of the external force determined from the sensory input received from each of the one or more second sensors.

11. The mobile communication device of claim 1, wherein the cut slot has one edge annexed to the press region and another edge extending perpendicularly from the press region toward an opposing side of the side wall of the mid-frame.

12. The mobile communication device of claim 1, wherein the cut slot has one edge separated from one side of the side wall by a gap and another edge extending perpendicularly toward an opposing side of the side wall.

13. A method for enabling a strain-based sensor configuration in a mobile communication device comprising:
configuring a section of a side wall encompassing a mid-frame of the mobile communication device to function as a press region;
providing a cut slot that is longer than the press region and extends in parallel to the press region inside the mid-frame; and
providing a plurality of sensors inside the cut slot to detect a side wall deformation caused by an external force.

14. The method of claim 13, further comprising extending the cut slot along the press region from one side of the press region to beyond another side of the press region.

15. The method of claim 13, further comprising extending the cut slot along the press region and beyond both sides of the press region.

16. The method of claim 13, further comprising:
providing one or more first sensors among the plurality of sensors in the cut slot within the press region to detect the external force applied in the press region; and
providing one or more second sensors among the plurality of sensors in the cut slot but outside the press region to detect the external force applied outside the press region.

17. The method of claim 16, further comprising providing the one or more second sensors on one side of the one or more first sensors.

18. The method of claim 16, further comprising providing the one or more second sensors on both sides of the one or more first sensors.

19. The method of claim 13, further comprising annexing one edge of the cut slot to the press region and extending another edge of the cut slot perpendicularly from the press region toward an opposing side of the side wall of the mid-frame.

20. The method of claim 13, further comprising separating one edge of the cut slot from one side of the side wall and extending another edge of the cut slot perpendicularly toward an opposing side of the side wall.
